(19) United States
(12) Patent Application Publication
(10) Pub. No.: US 2009/0235242 A1
(43) Pub. Date: Sep. 17, 2009

(54) IMAGE FORMING APPARATUS, REMOTE UPDATE VERIFICATION METHOD THEREFOR AND STORAGE MEDIUM

(75) Inventor: Tadashi Kawaguchi, Tokyo (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/367,944

(22) Filed: Feb. 9, 2009

(30) Foreign Application Priority Data
Feb. 7, 2008 (JP) 2008-027805

(51) Int. Cl. G06F 9/44

(52) U.S. Cl. 717/168

(57) ABSTRACT

An image forming apparatus which is capable of more reliably ensuring the operation of the apparatus having software files therein updated remotely and reducing an operational burden on the user. A ROM stores a plurality of software files. A scanner section and a printer section execute functions provided by the image forming apparatus, using the software files. An NIC section receives an update software file for updating at least one of the software files from an image processing apparatus. After a software file is updated based on the update software file received by the NIC section, a function using the updated software file is executed, a core section causes the image forming apparatus to operate in an functional check mode for checking operation of the executed function.

### BACKGROUND OF THE INVENTION

1. Field of the Invention

The present invention relates to an image forming apparatus which is capable of remotely updating a software file therein and then verifying whether or not the update has been normally completed, a remote update verification method for the image forming apparatus, and a storage medium storing a program for implementing the method.

2. Description of the Related Art

As the image forming apparatus, there may be mentioned a multifunction printer (hereinafter referred to as “the MFP”) incorporating an image scanner and a printer engine and connected to an external apparatus via a telephone line or a network. Further, as the software file provided for the image forming apparatus, there may be mentioned firmware.

As for a conventional MFP, in the case of updating software files therein, only when a service person or the like determines that the update is required in view of user's usage conditions, the service person visits a site where the MFP is installed and collectively updates the software files manually, for example. Further, in other cases, update software for use in update processing is transmitted to a site where the MFP is installed, to perform the update of the software files.

However, with an increase in the scale and function of the MFP, the size of firmware or the like is also increased. Therefore, to transfer the whole of firmware as a collective package is transferred and execute the update, it takes a non-negligible time period even for data transfer alone, and the update operations is rather troublesome. Further, after transmission of the firmware, it is required to carry out functional checks on a function-by-function basis so as to verify whether or not the update has been normally completed. Due to such a sequence of update operations, a time period becomes longer over which the use of the apparatus by the user is restricted, and the user operation is sometimes forcibly interrupted.

To solve this problem, a method has been employed in which firmware is divided into function-specific parts and is processed on a function-by-function basis so as to shorten a time period over which the user is forced to stop using the apparatus during a software update operation and to reduce workload imposed on the service person. For example, firmware is divided into a boot program part and other functional program parts associated with respective functions such as a system control function, a display control function, an image scanner control function, a printer engine control function, and a page description language (PDL) control function, and only a functional program part requiring update is updated. Further, there has also been known a service executed by a device management apparatus which is in charge of managing device information management and setting firmware update and functions as a gateway, and a distribution server for managing and distributing update firmware files for update, both provided on the Internet, for remotely updating firmware.

As a known patent literature on a technique for use in employing the above-mentioned new program configuration and firmware update service, for verifying whether or not an update has been normally completed, there may be mentioned, for example, Japanese Patent Laid-Open Publication No. 2006-215907. This publication discloses, as an update completion verification technique, a method of checking a device management apparatus whether or not a combination of respective firmware versions of functional units properly match. Further, as the above-mentioned verification technique, the publication discloses a technique for realizing labor saving and automation of test operation in which the device management apparatus performs a test on an image forming apparatus as a target and generates test results.

In the above prior art, however, the device management apparatus checks the firmware version information on the functional units, and hence even when the firmware versions of the respective functional units properly match, it is impossible to perform functional checks on a function-by-function basis as a service person conventionally does. That is, the above prior art suffers from the problem that it is impossible to sufficiently ensure a normal operation of the MFP after restart of the same.

Further, in the conventional verification technique, a testing tool per se is installed in the device management apparatus, and test items are registered in the device management apparatus side, for remotely performing a test associated with a test item selected by the device management apparatus. Therefore, even when the user desires to use the image forming apparatus during the test, there is a fear that the user cannot immediately use the apparatus, which constitutes a restriction on user's use conditions of the apparatus.

On the other hand, if all function-specific functional checks conventionally performed by the service person are left to the user, an operational burden on the user of the apparatus increases, forcing the user to do work which the user is not originally required to.

### SUMMARY OF THE INVENTION

The present invention provides an image forming apparatus which is capable of more reliably ensuring the operation of the apparatus having a software file therein updated remotely and reducing an operational burden on a user operating the apparatus, a remote update verification method for the image forming apparatus, and a storage medium storing a program for implementing the method. Further, the present invention provides an image forming apparatus which is capable of more reliably verifying completion of an update of the apparatus without restricting the operational conditions of the apparatus, a remote update verification method for the image forming apparatus, and a storage medium storing a program for implementing the method.

In a first aspect of the present invention, there is provided an image forming apparatus comprising a storage unit configured to store a plurality of softwares, an execution unit configured to execute functions provided by the image forming apparatus, using the softwares stored in the storage unit, a reception unit configured to receive an update software for updating at least one of the softwares stored in the storage unit from an information processing apparatus, and a control unit configured to be operable when, after the software is updated based on the update software received by the reception unit, a function using the updated software is executed out of the functions provided by the image forming apparatus, to cause the image forming apparatus to operate in an functional check mode for checking operation of the executed function.

In a second aspect of the present invention, there is provided an image forming apparatus comprising a storage unit configured to store a plurality of softwares, an execution unit configured to execute functions provided by the image forming apparatus, using the softwares stored in the storage unit, a reception unit configured to receive an update software for updating at least one of the softwares stored in the storage unit from an information processing apparatus, and a transmission unit configured to be operable when, after the software is updated based on the update software received by the reception unit, a function using the updated software is executed out of the functions provided by the image forming apparatus, to transmit results of execution of the function to the information processing apparatus.

In a third aspect of the present invention, there is provided a remote update verification method for an image forming apparatus, comprising storing a plurality of softwares, executing functions provided by the image forming apparatus, using the stored softwares, receiving an update software for updating at least one of the stored softwares from an information processing apparatus, and controlling such that when, after the software is updated based on the received update software, a function using the updated software is executed out of the functions provided by the image forming apparatus, the image forming apparatus is caused to operate in an functional check mode for checking operation of the executed function.

In a fourth aspect of the present invention, there is provided a remote update verification method for an image forming apparatus, comprising storing a plurality of softwares, executing functions provided by the image forming apparatus, using the stored softwares, receiving an update software for updating at least one of the stored softwares from an information processing apparatus, and transmitting, when, after the software is updated based on the received update software, a function using the updated software is executed out of the functions provided by the image forming apparatus, results of execution of the function to the information processing apparatus.

In a fifth aspect of the present invention, there is provided a computer-readable storage medium storing a computer program for causing a computer to execute a remote update verification method for an image forming apparatus, wherein the remote update verification method comprises storing a plurality of softwares, executing functions provided by the image forming apparatus, using the stored softwares, receiving an update software for updating at least one of the stored softwares from an information processing apparatus, and controlling such that when, after the software is updated based on the received update software, a function using the updated software is executed out of the functions provided by the image forming apparatus, the image forming apparatus is caused to operate in an functional check mode for checking operation of the executed function.

In a sixth aspect of the present invention, there is provided a computer-readable storage medium storing a computer program for causing a computer to execute a remote update verification method for an image forming apparatus, wherein the remote update verification method comprises storing a plurality of softwares, executing functions provided by the image forming apparatus, using the stored softwares, receiving an update software for updating at least one of the stored softwares from an information processing apparatus, and transmitting, when, after the software is updated based on the received update software, a function using the updated software is executed out of the functions provided by the image forming apparatus, results of execution of the function to the information processing apparatus.

According to the present invention, functional checks are performed when a function activated by an updated software file is executed for the first time after the update of the software file, or execution results obtained when the function is executed for the first time are sent to the device management device. This makes it possible to obtain the following advantageous effects: It is possible to more reliably ensure the operation of the apparatus after the update of the software file, minimize an operational burden on the user operating the apparatus, and verify whether or not the update of the software file in the image forming apparatus has been normally completed, without restricting the operational conditions of the apparatus.

The features and advantages of the invention will become more apparent from the following detailed description taken in conjunction with the accompanying drawings.

### BRIEF DESCRIPTION OF THE DRAWINGS

FIG. 1 is a diagram showing the general configuration of a remote software update system to which the present invention is applied.

FIG. 2 is a functional block diagram of an MFP whose software is to be remotely updated.

FIG. 3 is a functional block diagram of a device management apparatus which is applied to the present invention.

FIG. 4A is a flowchart of a verification process executed by the MFP in the remote update system in FIG. 1, for firmware update and verification (checking) after the update.

FIG. 4B is a continuation of the flowchart in FIG. 4A.

FIG. 5A is a flowchart of a verification process executed by a device management apparatus in the remote update system in FIG. 1, for firmware update and verification after the update.

FIG. 5B is a continuation of the flowchart in FIG. 5A.

FIG. 6 is a diagram useful in explaining code data including a change details table and firmware data stored in a program ROM as a target for update in an embodiment of the present invention.

FIG. 7 is a diagram of the program ROM as a target for update in the present embodiment and the change details table in a case where user check is not required.

FIG. 8 is a view of an example of a display control screen displayed when a general user logs in and uses a copy function.

FIG. 9 is a view of an example of a display control screen displayed when a version match check alone is performed after update processing, and an apparatus administrator logs in later.

### DETAILED DESCRIPTION OF THE EMBODIMENTS

The present invention will now be described in detail below with reference to the accompanying drawings showing an embodiment thereof.

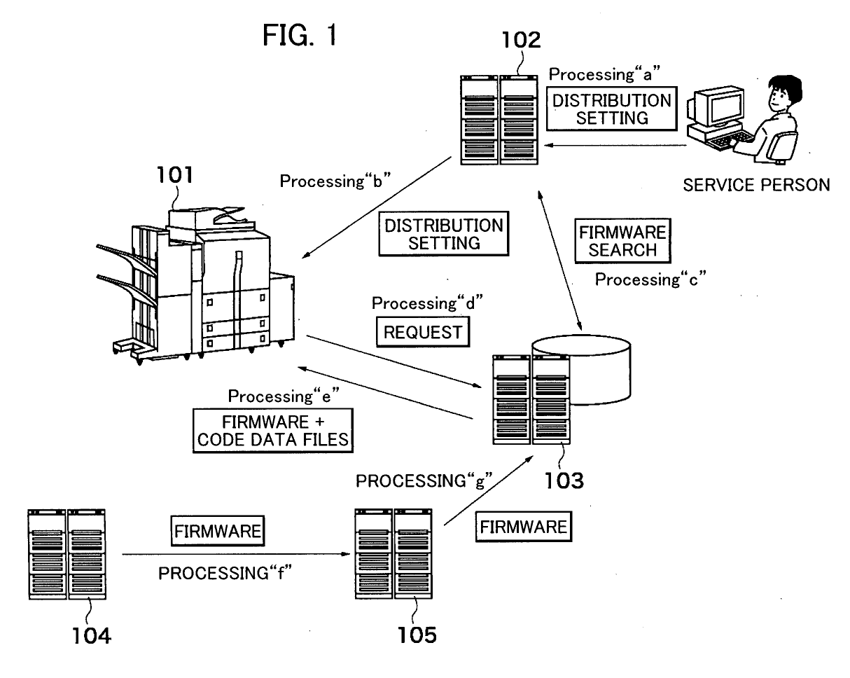

FIG. 1 is a diagram showing the general configuration of a remote software update system to which the present invention is applied.

As shown in FIG. 1, the remote software update system is basically comprised of an MFP 101 as an image forming apparatus, a device management apparatus 102 that cooperates with the MFP 101, a distribution server 103, a release server 104, and a pool server 105.

The MFP 101 includes an image scanner, a printer engine, and so forth, and is connected to external apparatuses via a telephone line or a network. The MFP 101 is an apparatus as a target for software update and a capability thereof is specified such that software files written e.g. in a ROM as a readable storage medium within the apparatus can be updated.

The device management apparatus 102 accommodates differences between communication media or transmission methods in the network to thereby enable communication between different models, manages device information associated with apparatuses connected to the network, is in charge of setting a software update, and functions as a gateway. The distribution server 103 manages update software files. When receiving a request from an apparatus as the update target, the distribution server 103 distributes associated update software files and various kinds of code data.

The release server 104 is connected to a network of a software development department of a company and functions as a first server to release software files from the development department. The pool server 105 is provided between the release server 104 and the distribution server 103, and stores software files distributed from the release server 104 in the past, as history.

In the system configured as above, remote update of the software of an MFP is performed, for example, as follows: When an event requiring software update occurs for some reason, a service person sets distribution information in the device management apparatus 102 so as to update software files to new ones (Processing “a”). The distribution information includes update date and time, the IP address of the target MFP, program versions before and after the update, the brief description of changes by the update, and so forth, for example. After the distribution information is set, the device management apparatus 102 transmits the distribution information to the MFP 101 as the target apparatus via the network, based on the configured distribution information (Processing “b”).

Whenever a software file is updated to a new one, the new software file is sent from the release server 104 to the pool server 105 and is stored therein (Processing f). Further, the software file is stored in the distribution server 103 (Processing g). The pool server 105 is comprised of a large-scale database for accumulating updated software files as history. On the other hand, the distribution server 103 stores only software files of past several versions as history. Further, the distribution server 103 is configured to control communication with apparatuses as targets for update.

Simultaneously with transmission of the distribution information to the MFP 101, the device management apparatus 102 searches the distribution server 103 for software files for update and designates the software files found by the search. At the same time, the device management apparatus 102 generates various kinds of code data, described hereinafter, and attaches the generated code data to the software files (Processing “c”). When the update is approved by the MFP 101 having received the distribution information, the MFP 101 sends approval information to the device management apparatus 102. The device management apparatus 102 activates (enables) distribution of the associated software files in the distribution server 103 and the code data. Then, when the designated date and time comes, the MFP 101 issues an update request to the distribution server 103 based on the distribution information (Processing “d”). The distribution server 103 having received the request distributes the software files and the code data (Processing “e”).

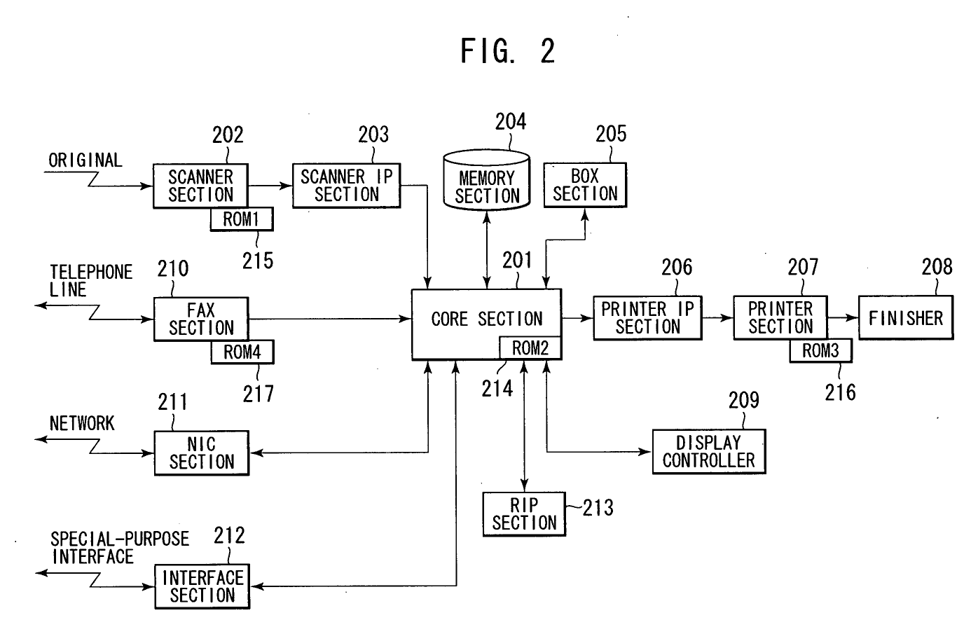

FIG. 2 is a functional block diagram of the MFP whose software is to be remotely updated.

As shown in FIG. 2, a core section 201 (control unit) is connected to a scanner IP 203 and a printer IP 206. In response to an instruction from a display controller 209, the core section 201 performs centralized overall control of the MFP, e.g. by performing access control of a scanner section 202 and a printer section 207 to perform image forming operation, and communicating with an external interface. It should be noted that IP of the scanner IP or the printer IP represents IP core (Intellectual Property Core), i.e. information on a partial hardware circuit consolidated for each functional unit when a control circuit is formed e.g. by an LSI.

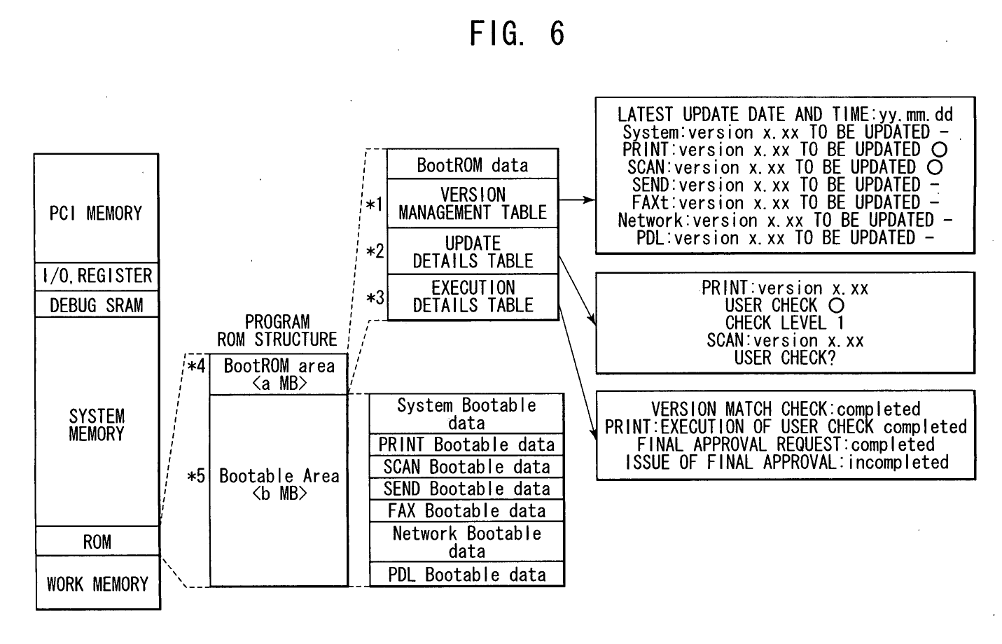

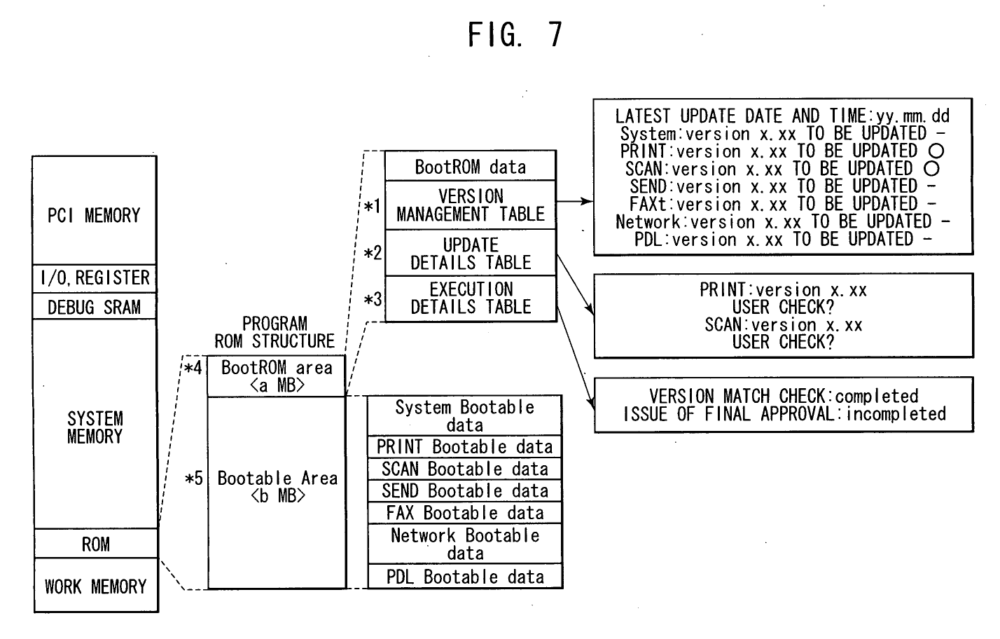

The core section 201 includes a ROM 2 (214), and the ROM 2 (214) (storage unit) stores a boot program containing the various kinds of code data, referred to hereinafter, and a system bootable program for centralized overall control of the MFP. Further, the ROM 2 stores a bootable program storing control processes for realizing a scan function, a print function, a fax function, and a file transmission (SEND) function, respectively, a NIC bootable program, a PDL bootable program, and so forth. The NIC bootable program is a process program for controlling communication with an external information apparatus, while the PDL bootable program is a process program for generating raster data (see FIGS. 6 and 7 described hereinafter).

The scanner section 202 (execution unit) reads an original image by a photoelectric conversion element and performs A/D conversion and shading correction on the original image to thereby generate an RGB digital image. The scanner section 202 includes a ROM 1 (215). The ROM 1 (215) stores programs for carrying out scan-related operations including sheet feeding, sheet conveyance, driving of an optical system, control of various sensors, and correction, control, and transfer of input and output image data.

The scanner IP section 203 includes a circuit block for performing reader-related image processing on the RGB digital image data output from the scanner section 202. A memory section 204 is a readable and writable storage device which functions as a main memory of the core section 201 and is used as a work area for imaging processing and an area for loading printout information. A box section 205 is used as a buffer area for image accumulation and for receiving data from the external interface.

The printer IP section 206 includes a circuit block for performing printer-related image processing on color component signals of respective colors Y, M, C, and K output from the core section 201, to thereby generate output video signals.

The printer section 207 (execution unit) develops, transfers, and fixes an output video signal on a recording sheet in accordance with the start of a printing operation. The printer section 207 includes a ROM 3 (216). The ROM 3 (216) stores programs for carrying out various controls concerning printing operations. The controls concerning printing operations include sheet feeding, sheet conveyance, driving of an optical system, control of various sensors, high-voltage control for image formation, control of a laser scanner and units for developing and fixing, control of output video data, and control of a finishing function.

A finisher 208 carries out post-processing, such as sorting and stapling, on recording sheets output from the printer section 207. The display controller 209 communicates with the core section 201 and detects e.g. key depression and the like, followed by displaying a status message indicative of the current system status.

A FAX section 210 is connected to an analog/digital public communication line, and is capable of transmitting and receiving images. The FAX section 210 includes a ROM 4 (217). The ROM 4 (217) stores programs for performing public line control, control and transfer of transmit/receive image data, control of transfer setting, and so forth, respectively.

A NIC section 211 controls communication with an external information apparatus via the network, and performs recording and information processing according to various applications. An interface section 212 has a special-purpose interface for controlling a USB storage unit, an image pickup device, a card reader for enabling accounting control and department designation control, and so forth. A RIP section 213 generates raster pattern data based on print information from an external information apparatus.

An update program is sent to the MFP configured as above, via the network, and then is transferred to the memory section 204 via the NIC section 211 (transmission unit, reception unit) so as to be temporarily stored therein. Then, data is transferred to a target ROM while referring to the various code data, referred to hereinafter, whereby the update program is written into the ROM. It should be noted that whichever of the ROMs 1, 2, 3, and 4 is designated as a storage for the update program, the above-mentioned method is employed.

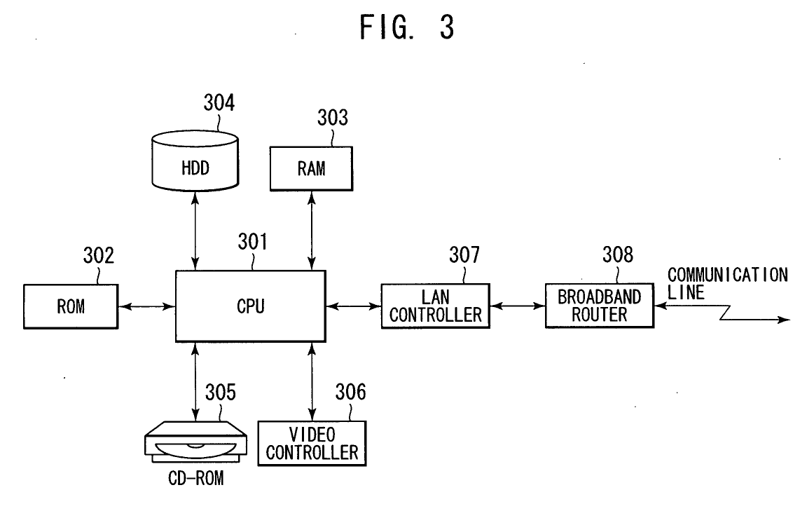

FIG. 3 is a functional block diagram of the device management apparatus which is applied to the present invention. The device management apparatus performs management of device information and update setting. The device management apparatus is required to provide services by transmitting and receiving information to and from a large number of clients, and therefore the device management apparatus has a system configuration attaching more importance to processing capability, fault tolerance, and expansibility than the system configuration of PCs for individual personal use do.

As shown in FIG. 3, the device management apparatus is basically comprised of a CPU 301, a ROM 302, a RAM 303, an HDD 304, a CD-ROM drive 305, a video controller 306, and a LAN controller 307 each connected to the CPU 301, and a broadband router 308.

The CPU 301 is a high-performance CPU exclusively for use in a server, and can be doubly or quadruply expanded according to its processing capability. The ROM 302 stores a program for controlling the overall operation of the device management apparatus. The RAM 303 functions as a main memory, and can be accessed at high speed so as to enhance its processing capability. The HDD 304 operates for accumulation of information, and has a structure multiplexed by mirroring for data protection.

The CD-ROM drive 305 is used as an interface for backing up information, installing a server application, etc. The video controller 306 operates to improve rendering speed, resolution, and 3D performance to thereby realize a sophisticated graphic function. The LAN controller 307 controls communication with clients via the network. The broadband router 308 is a communication device for performing routing for connection to the broadband Internet line. It should be noted that each of the distribution server 103, the release server 104, and the pool server 105 in the present embodiment has the same hardware configuration as that of the device management apparatus 102 as shown in FIG. 3, and these apparatuses can be regarded as examples of the information processing apparatus in the present invention.

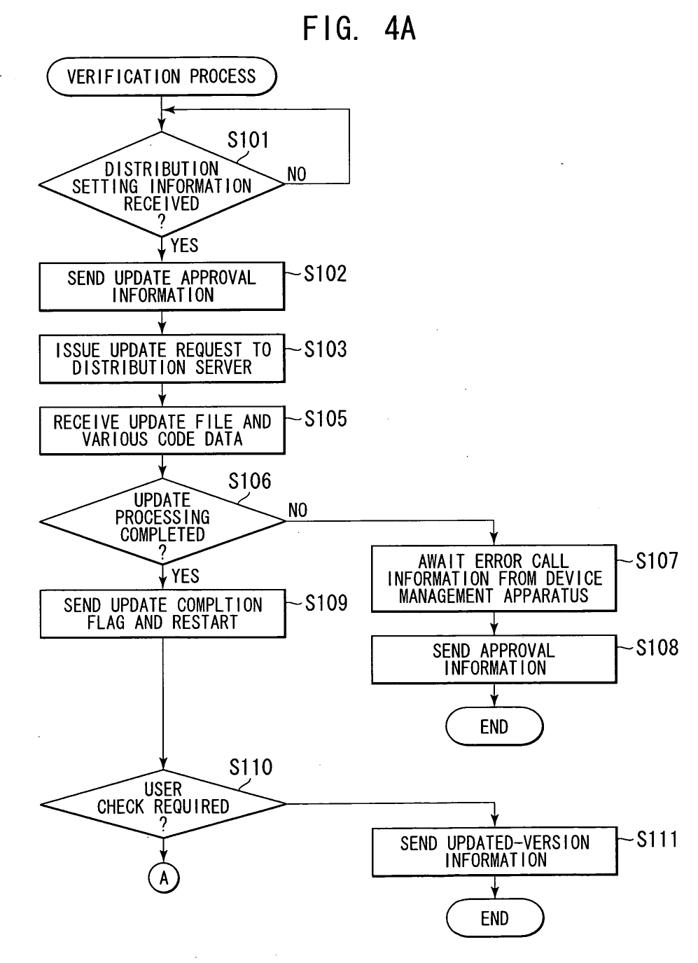

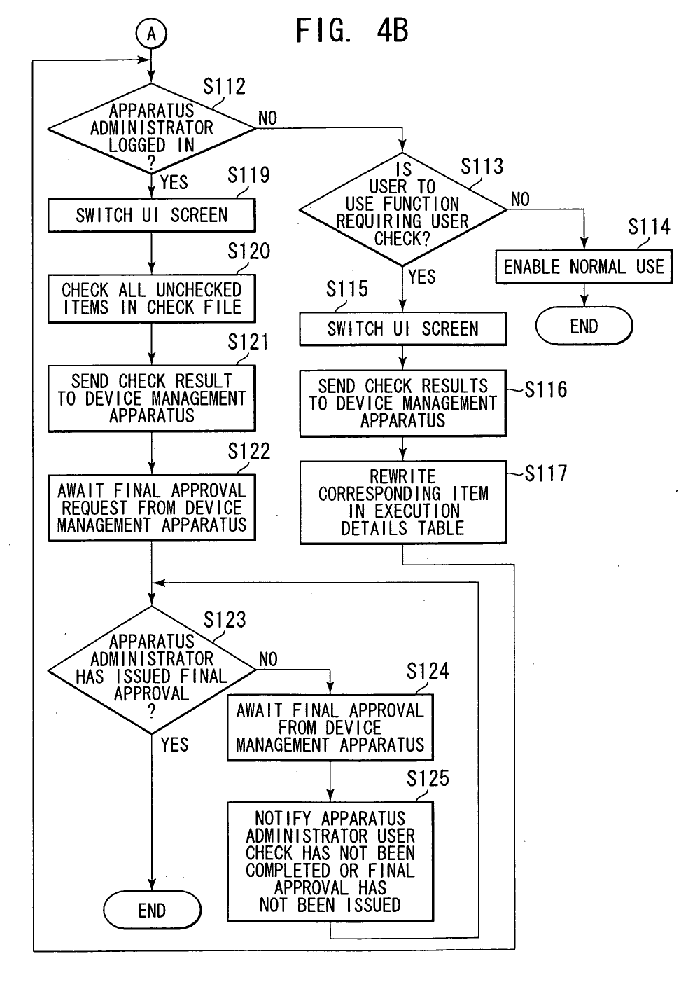

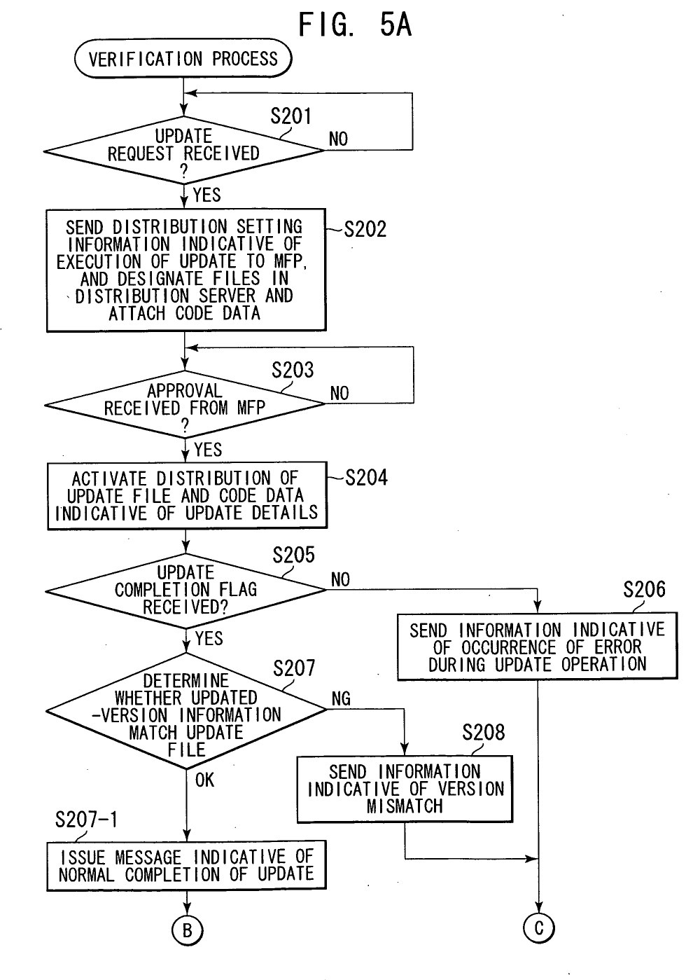

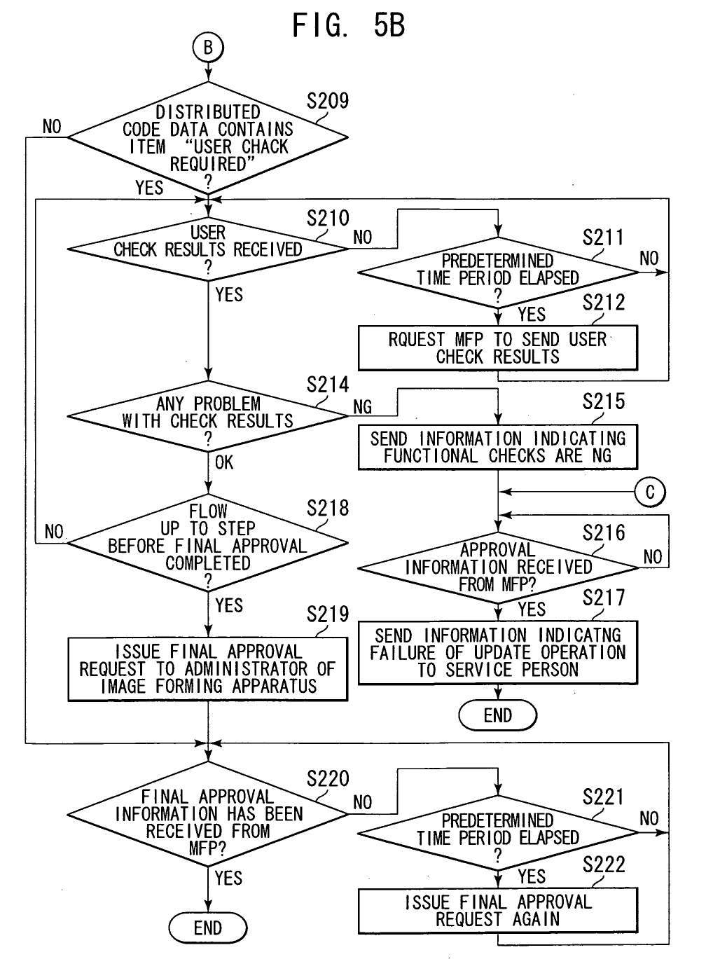

In the following, the operation of the remote update system including the MFP 101 and the device management apparatus 102 will be described with reference to FIGS. 4A and 4B to FIG. 9 by dividing the operation basically into two parts, i.e. the operation of the MFP 101 (FIGS. 4A and 4B) and the operation of the device management apparatus 102 (FIGS. 5A and 5B). It should be noted that in the present embodiment, a description will be given of a case where the firmware of the MFP 101 is updated, for convenience of description. The present embodiment can also be applied to the update of software files other than firmware, e.g. the update of a license-managed application file. In this case as well, the same advantageous effects as in the update of firmware can be provided.

FIGS. 4A and 4B are a flowchart of a verification process executed by the MFP 101 in the remote update system in FIG. 1, for firmware update and verification after the update.

The update of the firmware of the MFP 101 is started only when a service person and an end-user make a decision on updating the firmware of the MFP 101. When the decision is made, the service person searches the distribution server 103 for firmware for the update. Then, the service person registers the contents of the update firmware, update date and time, etc. in the device management apparatus 102, and issues an update request.

When the verification process including the remote update is started, the MFP 101 executes the verification process, following the flowchart shown in FIGS. 4A and 4B. First, it is determined whether or not distribution setting information indicative of execution of an update of the firmware has been received (step S101). If distribution setting information has not been received, the step S101 is repeatedly carried out until distribution setting information is received. On the other hand, if distribution setting information has been received from the device management apparatus 102, approval information indicative of permission of the update is sent to the device management apparatus 102 on condition that an apparatus administrator's has confirmed the information (step S102).

Next, based on the firmware distribution setting information received from the device management apparatus 102, the MFP 101 sends an update request to the distribution server 103 on the designated date and time (step S103). Then, the MFP 101 receives update firmware files and code data distributed from the distribution server 103 in response to the update request (step S105).

Now, a description will be given of the structure of firmware data and that of code data indicative of details of the update.

FIG. 6 is a diagram useful in explaining the code data including the change details table and the firmware data stored in the program ROM 2 (214) as a target for update in the present embodiment.

Referring to FIG. 6, the firmware data and the code data including the change details table show a case where user check is required. The code data includes a version management table (*1), the change details table (*2), and an execution details table (*3). The code data is stored e.g. in a BootROM area (*4) where BootROM data is stored.

The version management table describes, for each ROM, the current version number of each function-specific firmware file, which firmware is associated with the update, and latest update date and time.

The change details table records whether or not an end-user is required to check firmware updated by the present update operation and a level of the check.

The execution details table records whether or not version match check has been completed, whether or not end-user check has been completed, whether or not a final approval request has been completed, and whether or not a final approval has been completed.

The BootROM area storing the various code data and a firmware area (Bootable Area) (*5) storing programs for controlling respective functional units are respective different areas. The code data is stored in the BootROM area different from the Bootable Area (*5) so as to make it easier to refer to the code data.

In the case of the illustrated example, the version management table stores information indicating that a Print Bootable area for controlling the printer engine and a Scan Bootable area for controlling the image scanner are to be updated. Therefore, when this information is checked, the change details table is referred to immediately. The change details table stores information indicative of whether or not each of firmware in the Print Bootable Area and firmware in the Scan Bootable Area needs user check after the update. User check is an operation which an end-user carries out by printing out an image (PG) generated by actually operating the MFP 101 or reading the PG and comparing the PG with reference image data. In FIG. 6, information in the change details table indicates that only the firmware in the Print Bootable Area needs user check.

When user check is required, a check level is set for the user check, whereby it is possible to associate work load to be imposed on the end-user with update details of firmware to be updated, in advance. For example, when the check level is set to “Level 1”, a single image is printed out in default settings without any change in the settings, and when the check level is set to “Level 2”, a plurality of images are printed out, or an image is output after changing the settings of an image size for a reduced/enlarged-size output, hues and densities of colors of the image, etc.

FIG. 7 is a diagram useful in explaining the code data including the change details table and the firmware data stored in the program ROM 2 (214) as a target for update in the present embodiment, in the case where user check is not required.

FIG. 7 is identical to FIG. 6 except that the firmware in the Print Bootable area (i.e. part of the change details table (*2) does not need user check, either, and part of the execution details table (*3)) is omitted, and therefore duplicate description thereof is omitted.

In the MFP 101, when the update firmware files and the associated code data are received from the distribution server 103 (step S105), update of the firmware is performed e.g. according to the code data in FIG. 6.

After the update of the firmware is performed, first, the MFP 101 determines whether or not the update processing has been completed (step S106). If the update processing has not been completed, the MFP 101 enters a state of awaiting reception of error call information from the device management apparatus 102 (step S107). After having received the error call information, the MFP 101 sends approval information on the error call information to the device management apparatus 102 (step S108), followed by terminating the present process.

On the other hand, if determining in the step S106 that the update processing has been completed, the MFP 101 sends a notification (flag) indicative of completion of the update processing to the device management apparatus 102 (step S109), followed by restarting itself so as to cause reflect various updated settings to be reflected on execution of the associated programs.

After the restart, first, the MFP 101 starts the boot program, and then determines, by referring to the version management table in the code data, whether or not the code data contains an indication indicating that user check is required (step S110). If it is determined in the step S110 that user check is not required, the MFP 101 extracts only program version information associated with the updated functional units from the version management table and sends the extracted program version information to the device management apparatus 102 (step S111), followed by terminating the present process.

On the other hand, if it is determined in the step S110 that user check is required, the MFP 101 sends the program version information associated with each of the functional units to the device management apparatus 102, and then determines whether the end-user having logged in is the apparatus administrator or a general user (step S112).

If it is determined that a general user other than the apparatus administrator has logged in, the MFP 101 determines whether or not a function of the MFP 101 that the general user intends to use needs user check (step S113). If the function does not need user check, the MFP 101 enables general use (step S114), followed by terminating the present process. For example, the change details table in FIG. 6 indicates that only a print operation needs user check, and therefore when the general user desires to use the fax function or the send function which does not involve the print operation, general use of the fax function or the send function is permitted. In this case, the general user uses the MFP 101 unaware that update processing has been executed.

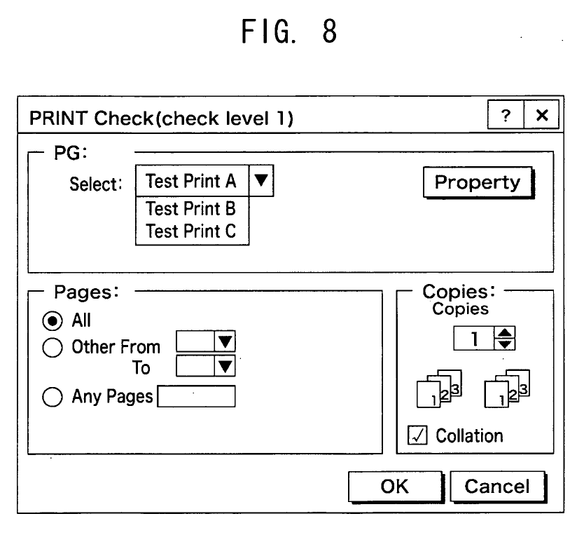

On the other hand, if it is determined in the step S113 that user check is required, e.g. in a case where the copy function involving the print operation is used, the MFP 101 switches an original display control screen for copying to a display control screen shown in FIG. 8 by way of example (step S115).

FIG. 8 is a view of an example of the display control screen displayed when the general user having logged in uses the copy function. As shown in FIG. 8, the display control screen indicates that user check is required when the print function is to be used and that the check level is set to “1”, and prompts the user to select a PG to be output and designate pages to be printed and the number of copies.

Thus, when user check is required, the function is executed according to settings input to the display control screen in FIG. 8 by the general user. Then, finally, printed-out data is sent to the device management server 102 from which information indicating a transmission destination was received in advance, so as to leave judgment to the device management server 102 (step S116). In this case, the general user may carry out re-scanning the printout to thereby execute self-check within the MFP 101.

When the check on the print function is completed, the MFP 101 rewrites an item ‘PRINT: USER CHECK EXECUTION’ in the execution details table (*3) in the code data to “completed” (step S117). Then, even when a function involving the print operation is to be used, the MFP 101 performs a normal operation without referring to the code data. More specifically, the process returns to the step S112, wherein it is determined whether a next user to use the apparatus is a general user or the apparatus administrator.

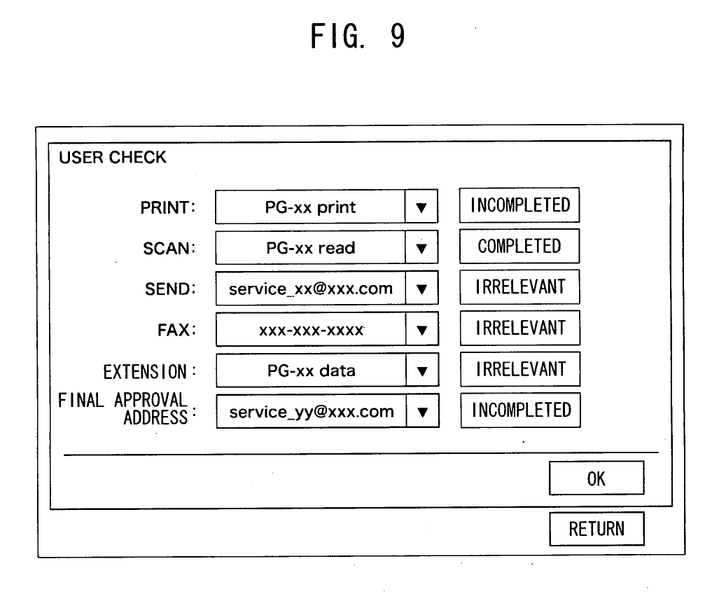

On the other hand, if it is determined in the step S112 that the user having logged in is the apparatus administrator, the MFP 101 switches the original display control screen for copying to a display control screen for the administrator (FIG. 9) whichever function is to be used, and urges the administrator to execute an entire check flow up to final approval of the update (step S119).

FIG. 9 is a view of an example of the display control screen displayed when only version match check is performed after the update processing and then the apparatus administrator logs in.

In this case, from the contents of the code data, it is known that only the Print Bootable area for controlling the printer engine and the Scan Bootable area for controlling the image scanner have been updated. Therefore, in FIG. 9, only the print function and the scan function have respective items activated for reflecting user check results, and the send function, the fax function, and the extension function other than them have respective items set to “irrelevant”. As for the print function which needs user check, the user check is not completed, and hence the check result is displayed as “incompleted”. On the other hand, as for the scan function, since user check is not required (see FIG. 6), the check result is displayed as “completed”. Further, execution of user check requires final approval by an external apparatus, and therefore the address of the device management apparatus 102 is displayed in an item “final approval destination address”. In this case, since the approval is not completed, the check result is displayed as “incompleted”.

The entire check flow up to the final approval of the update is executed as follows: Unchecked items associated with functions requiring user check are all checked according to the FIG. 9 display control screen, based on determination by the device management apparatus 102 or determination by self-check, as in the general user's case (step S120). At this time, if a single function check by the general user has been completed, the check on the single function is excluded from the administrator's check flow.

Next, the MFP 101 sends the check results to the device management apparatus 102 (step S121), and enters a state of awaiting a final approval request from the device management apparatus 102 (step S122). At this time, the MFP 101 rewrites the item ‘final approval request’ in the code data (FIG. 6) to “completed”, and then additionally writes the address of the device management apparatus 102 into the item “final approval destination address” in the display control screen for the administrator (FIG. 9) and activates the setting.

Thereafter, the final approval request is received, and it is determined whether or not the final approval has been has issued by the apparatus administrator 102 (step S123). If the final approval has been issued by the apparatus administrator, the present process is terminated.

On the other hand, if it cannot be confirmed that the final approval has been issued by the apparatus administrator, the MFP 101 enters a state of awaiting the final approval from the administrator (step S124). The MFP 101 awaiting the final approval or having received the final approval request again notifies the apparatus administrator of information based on the execution details table in the code data, to the effect that user check is not completed or that the administrator's final approval is not completed. The MFP 101 thus urges the apparatus administrator by the notification to complete checks promptly, followed by the process returning to the step S123 (step S125). It should be noted that this notification from the MFP 101 to the apparatus administrator may be performed by sending an e-mail based on address book information registered in the apparatus, or outputting an administrator code and a message indicating necessity of an early check, to the display control screen.

According to the process in FIGS. 4A and 4B, distribution setting information is received from the device management apparatus 102 (step S101), and update firmware files and code data are received from the distribution server 103 (step S105), whereafter update processing is executed. Then, updated version information is sent to the device management apparatus 102 (steps S11), user check is performed as required (step S120), and check results are sent to the device management apparatus 102 (step S121). Then, when the device management apparatus 102 determines that there is no problem with the check results, a final approval is issued according to a final approval request (step S123), followed by terminating the present process. Thus, the process in FIGS. 4A and 4B makes it possible to remotely update software files in each apparatus and then reliably ensure the operation of the apparatus. Further, the process makes it possible to minimize an operational burden on the user operating the apparatus, without restricting the operational conditions of the apparatus.

Next, a description will be given of the operation of the device management apparatus 102.

FIGS. 5A and 5B are flowcharts of a verification process executed by the device management apparatus 102 in the remote update system in FIG. 1, for firmware update and verification (check) after the update.

When the remote update processing is started, the device management apparatus 102 carries out the verification process, following the flowchart shown in FIGS. 5A and 5B. First, the device management apparatus 102 determines whether or not an update request signal has been received (step S201). If the update request signal has not been received, the step S201 is repeatedly carried out. On the other hand, if the update request signal has been received, the device management apparatus 102 sends distribution setting information containing date and time, an update outline, etc. for example, to the MFP 101 as a target for the update to thereby notify the MFP 101 that a firmware update will be executed. At the same time, the device management apparatus 102 searches the distribution server 103 for update software files and designates the same. Then, the device management apparatus 102 generates various code data (see FIGS. 6 and 7) and attaches the generated code data to the software file (step S202).

After completion of transmission of the distribution setting information to the MFP 101, the process proceeds to a determination step for determining whether or not information indicative of permission of the update has been received from the MFP 101 (step S203). If the information has not been received, the step is repeatedly carried out until the information is received. On the other hand, if the information has been received, it is judged that the firmware distribution setting information has been approved by the user, and distribution of the update files and the code data indicative of update details from the distribution server 103 is activated (step S204).

After activation of the distribution of the update files and the code data indicative of the update details, the device management apparatus 102 enters a state for receiving an update completion flag from the MFP 101 and determines whether or not the update completion flag has been received (step S205). If a predetermined time period has elapsed without receiving the update completion flag, the device management apparatus 102 sends information indicating that an error occurred during the update operation to the MFP 101 (step S206).

Thereafter, the device management apparatus 102 enters a state of waiting for approval information which is to be sent from the MFP 101 as a result of checking the information transmitted in the preceding step (the step S206 in the present case), and determines whether or not the approval information has been received (step S216). If the approval information has not been received, the step S216 is repeatedly carried out until the approval information is received. On the other hand, if the approval information has been received from the MFP 101, the device management apparatus 102 notifies information indicating that the update operation failed for some reason to the service person (step S217), followed by terminating the present process.

On the other hand, if it is determined in the step S205 that the update completion flag has been received, the device management apparatus 102 determines whether or not updated-version information sent from the MFP 101 matches the version of the update firmware sent to the MFP 101 (step S207). If the former does not match the latter, the device management apparatus 102 sends information indicative of the version mismatch to the MFP 101 (step S208), followed by the process proceeding to the step S216.

On the other hand, if it is determined in the step S207 that the version information sent from the MFP 101 matches the version of the update firmware sent to the MFP 101, the device management apparatus 102 issues a message indicative of normal completion of the update to the MFP 101 (step S207-1). Then, the device management apparatus 102 determines whether or not the distributed code data contains an item specifying that user check is required (step S209). If user check is not required, an item ‘final approval issue’ in the execution details table in the code data is rewritten to “completed” by the MFP 101 having received the normal update completion message. Thereafter, it is determined whether or not a final approval issued by the MFP 101 has been received (step S220), and if the final approval has been received, the present process is terminated.

On the other hand, if the final approval has not been received from the MFP 101, the device management apparatus 102 measures a time period elapsed after the distribution servers 103 distributed the update firmware data and the code data indicative of the update details (step S221). Thereafter, the steps S220 and S221 are repeatedly carried out until a predetermined time period elapses. Then, when the predetermined time period elapses, the device management apparatus 102 issues the final approval request to the MFP 101 again (step S222), followed by the process returning to the step S220.

It should be noted that when user check is not required, the MFP 101 automatically exchanges information with the device management apparatus 102 all through the control flow, without using the display control screen (see FIG. 7).

On the other hand, if it is determined in the step S209 that user check is required, the device management apparatus 102 enters a state for receiving user check results, and determines whether or not user check results have been received from the MFP 101 (step S210). If user check results have not been received, the device management apparatus 102 determines whether or not a predetermined time period has elapsed (step S211). Then, the steps S210 and S211 are repeatedly carried out until the predetermined time period elapses. On the other hand, if it is determined in the step S211 that the predetermined time period has elapsed, the device management apparatus 102 requests the MFP 101 to send user check results (step S212), followed by the process returning to the step S210.

If it is determined in the step S210 that user check results have been received, the device management apparatus 102 determines whether or not there is any problem with the received user check results (step S214). If there is any problem with the received user check results, the device management apparatus 102 sends information indicating that the user check results are not good to the MFP 101 (step S215), followed by the process proceeding to the step S216. On the other hand, if it is determined in the step S214 that there is no problem with the check results, it is determined whether or not the flow of the process up to the step immediately before the final approval has been completed (step S218). If it is determined that the flow of the process up to the step has not been completed, the process returns to the step S210. On the other hand, if it is determined in the step S218 that the flow of the process up to the step immediately before the final approval has been completed, the device management apparatus 102 issues the final approval request to the administrator of the MFP 101, with reception of all check result information from the MFP 101 as a trigger (step S219).

After having sent the final approval request to the MFP 101, the device management apparatus 102 enters a state for receiving a final approval from the MFP 101, and determines whether or not the final approval has been received, as in the case where user check is not required (step S220). If it is determined that the final approval has been received, the present process is terminated.

On the other hand, if it is determined in the step S220 that the final approval has not been received from the MFP 101, the device management apparatus 102 measures a time period elapsed after the distribution servers 103 distributed the update firmware data etc., as in the case where user check is not required (step S221). Thereafter, similarly, the steps S220 and S221 are repeatedly carried out until the predetermined time period elapses. Then, when the predetermined time period elapses, the device management apparatus 102 issues the final approval request to the MFP 101 again (step S222), followed by the process returning to the step S220.

According to the process in FIGS. 5A and 5B, the update distribution setting information is distributed to the MFP 101 (step S202), and when user check is not required after completion of the update processing, the final approval is received from the MFP 101, followed by terminating the present process (step S220). On the other hand, when user check is required, it is checked whether or not there is any problem with the check results sent from the MFP 101 (step S214). Therefore, it is possible to reliably ensure the operation of the apparatus after execution of the remote update of software files, as well as to minimize an operational burden on the user operating the apparatus, without restricting the operational conditions of the apparatus.

According to the present embodiment, code data is distributed from the distribution server 103 together with firmware data, and the MFP 101 refers to the code data and performs an operation including control of the display control screen so as to effectively switch between items to be checked after the update. This makes it possible not only to reliably ensure the operation of the MFP 101 after execution of the remote update of software files, but also to check whether or not update processing in the MFP 101 has been normally completed, while minimizing an operational burden on the user operating the apparatus, without restricting the operational conditions of the apparatus.

Although in the present embodiment, only contents of the ROM 2 (214) of the core section 201 of the MFP 101 are updated for convenience of description, contents of the ROM 1 (215), the ROM 3 (216), and the ROM 4 (217) can be updated in the same way. More specifically, also in the case of updating the contents in the ROM 1 (215), the ROM 3 (216), or the ROM 4 (217), update of the ROM, user check, and final approval can be performed under centralized management based on the associated code data in the ROM 2 (214).

In the present embodiment, in the case of using a function corresponding to updated software anew, function check is performed only when code data attached to an update software file sent from the server contains an indication (flag) indicating that check is required. However, as to functions corresponding to updated software, function check may be performed on any function corresponding to the updated software when it is used for the first time after the update, even when the associated code data does not contain an indication indicative of necessity of check at the time of restart, i.e. irrespective of whether or not a flag indicating that check is required is set in the associated code data. In this case, function check is not performed on functions started by unupdated software.

Further, although in the present embodiment, the device management apparatus 102 and the distribution server 103 are provided as separate apparatuses, these may be integrated into a single information processing apparatus.

Further, it is to be understood that the present invention may also be accomplished by supplying a system or an apparatus with a storage medium in which a program code of software, which realizes the functions of the above described embodiment, is stored, and causing a computer (or CPU or MPU) of the system or apparatus to read out and execute the program code stored in the storage medium.

In this case, the program code itself read from the storage medium realizes the functions of the above described embodiment, and therefore the program code and the storage medium in which the program code is stored constitute the present invention.

Examples of the storage medium for supplying the program code include a floppy (registered trademark) disk, a hard disk, a magnetic-optical disk, an optical disk, such as a CD-ROM, a CD-R, a CD-RW, a DVD-ROM, a DVD-RAM, a DVD-RW, or a DVD+RW, a magnetic tape, a nonvolatile memory card, and a ROM. Alternatively, the program may be downloaded via a network.

Further, it is to be understood that the functions of the above described embodiment may be accomplished not only by executing the program code read out by a computer, but also by causing an OS (operating system) or the like which operates on the computer to perform a part or all of the actual operations based on instructions of the program code.

Further, it is to be understood that the functions of the above described embodiment may be accomplished by writing a program code read out from the storage medium into a memory provided on an expansion board inserted into a computer or a memory provided in an expansion unit connected to the computer and then causing a CPU or the like provided in the expansion board or the expansion unit to perform a part or all of the actual operations based on instructions of the program code.

While the present invention has been described with reference to an exemplary embodiment, it is to be understood that the invention is not limited to the disclosed exemplary embodiment. The scope of the following claims is to be accorded the broadest interpretation so as to encompass all modifications, equivalent structures and functions.

This application claims priority from Japanese Patent Application No. 2008-027805 filed Feb. 7, 2008, which is hereby incorporated by reference herein in its entirety.

What is claimed is:

1. An image forming apparatus comprising:
a storage unit configured to store a plurality of softwares;
an execution unit configured to execute functions provided by the image forming apparatus, using the softwares stored in said storage unit;
a reception unit configured to receive an update software for updating at least one of the softwares stored in said storage unit from an information processing apparatus; and
a control unit configured to be operable when, after the software is updated based on the update software received by said reception unit, a function using the updated software is executed out of the functions provided by the image forming apparatus, to cause the image forming apparatus to operate in an functional check mode for checking operation of the executed function.

2. The image forming apparatus according to claim 1, comprising a determination unit configured to determine whether or not data attached to the update software received by said reception unit contains a demand for a functional check to be executed after the update of the software, and
wherein when it is determined that there is a demand for the functional check to be executed after the update of the software, said control unit causes the image forming apparatus to operate in the functional check mode, and when it is determined that there is no demand for the functional check, said control unit causes the image forming apparatus to operate in a normal operation mode.

3. The image forming apparatus according to claim 1, comprising a transmission unit configured to transmit results of operation of the image forming apparatus in the functional check mode to the information processing apparatus or another information processing apparatus.

4. The image forming apparatus according to claim 1, wherein when a first user to use the image forming apparatus after the update of the software is an apparatus administrator of the image forming apparatus, said control unit causes the image forming apparatus to operate, irrespective of a function is a function to be executed by the user, in an operation mode for carrying out functional checks on all functions using the updated software.

5. The image forming apparatus according to claim 1, wherein when a first user to use the image forming apparatus after the update of the software is not an apparatus administrator of the image forming apparatus, if a function to be executed by the user does not use the updated software, said control unit does not cause the image forming apparatus to operate in the functional check mode.

6. The image forming apparatus according to claim 5, wherein after the user who is not the apparatus administrator of the image forming apparatus has executed the function using the updated software, when the apparatus administrator of the image forming apparatus executes a function using the updated software, said control unit causes the image forming apparatus to operate in an functional check mode for carrying out functional checks on all functions using the updated software except functions checked based on execution thereof by the user who is not the apparatus administrator of the image forming apparatus.

7. An image forming apparatus comprising:
a storage unit configured to store a plurality of softwares;
an execution unit configured to execute functions provided by the image forming apparatus, using the softwares stored in said storage unit;
a reception unit configured to receive an update software for updating at least one of the softwares stored in said storage unit from an information processing apparatus; and
a transmission unit configured to be operable when, after the software is updated based on the update software received by said reception unit, a function using the updated software is executed out of the functions provided by the image forming apparatus, to transmit results of execution of the function to the information processing apparatus.

8. The image forming apparatus according to claim 7, comprising a determination unit configured to determine whether or not data attached to the update software received by said reception unit contains a demand for a functional check to be executed after the update of the software, and
wherein when it is determined that there is a demand for the functional check to be executed after the update of the software, said transmission unit transmits the results of execution of the function to the information processing apparatus.

9. The image forming apparatus according to claim 7, wherein when a first user to use the image forming apparatus after the update of the software is an apparatus administrator of the image forming apparatus, said transmission unit transmits the results of execution of all functions using the updated software to the information processing apparatus.

10. The image forming apparatus according to claim 7, wherein when a first user to use the image forming apparatus after the update of the software is not an apparatus administrator of the image forming apparatus, if a function to be executed by the user does not use the updated software, said transmission unit does not transmit the results of execution of the function to the information processing apparatus.

11. The image forming apparatus according to claim 10, wherein after the user who is not the apparatus administrator of the image forming apparatus has executed the function using the updated software, when the apparatus administrator of the image forming apparatus executes a function using the updated software, said transmission unit transmits the results of execution of all functions using the updated software except functions of which the results of execution by the user who is not the apparatus administrator of the image forming apparatus have been transmitted to the image forming apparatus.

12. A remote update verification method for an image forming apparatus, comprising:
storing a plurality of softwares;
executing functions provided by the image forming apparatus, using the stored softwares;
receiving an update software for updating at least one of the stored softwares from an information processing apparatus; and
controlling such that when, after the software is updated based on the received update software, a function using the updated software is executed out of the functions provided by the image forming apparatus, the image forming apparatus is caused to operate in an functional check mode for checking operation of the executed function.

13. A remote update verification method for an image forming apparatus, comprising:
storing a plurality of softwares;
executing functions provided by the image forming apparatus, using the stored softwares;
receiving an update software for updating at least one of the stored softwares from an information processing apparatus; and
transmitting, when, after the software is updated based on the received update software, a function using the updated software is executed out of the functions provided by the image forming apparatus, results of execution of the function to the information processing apparatus.

14. A computer-readable storage medium storing a computer program for causing a computer to execute a remote update verification method for an image forming apparatus,
wherein the remote update verification method comprises:
storing a plurality of softwares;
executing functions provided by the image forming apparatus, using the stored softwares;
receiving an update software for updating at least one of the stored softwares from an information processing apparatus; and
controlling such that when, after the software is updated based on the received update software, a function using the updated software is executed out of the functions provided by the image forming apparatus, the image forming apparatus is caused to operate in an functional check mode for checking operation of the executed function.

15. A computer-readable storage medium storing a computer program for causing a computer to execute a remote update verification method for an image forming apparatus,
wherein the remote update verification method comprises:
storing a plurality of softwares;
executing functions provided by the image forming apparatus, using the stored softwares;
receiving an update software for updating at least one of the stored softwares from an information processing apparatus; and
transmitting, when, after the software is updated based on the received update software, a function using the updated software is executed out of the functions provided by the image forming apparatus, results of execution of the function to the information processing apparatus.
